(19) United States
(12) Patent Application Publication
(10) Pub. No.: US 2026/0295400 A1
(43) Pub. Date: Oct. 1, 2026

(54) THREE-DIMENSIONAL PLACEHOLDER REPRESENTATIONS OF LARGE-SCALE ASSETS IN GAMING APPLICATIONS

(71) Applicants: Sony Interactive Entertainment Inc., Tokyo (JP); Sony Interactive Entertainment LLC, San Mateo, CA (US)

(72) Inventors: Jeffrey R. Stafford, Redwood City, CA (US); Joseph Logan Olson, Glendale, CA (US); Nathan Gross, Aliso Viejo, CA (US); Bandaly Azzam, Anaheim Hills, CA (US)

(73) Assignees: Sony Interactive Entertainment Inc., Tokyo (JP); Sony Interactive Entertainment LLC, San Mateo, CA (US)

(21) Appl. No.: 19/097,112

(22) Filed: Apr. 1, 2025

(51) Int. Cl. A63F 13/358; A63F 13/525; G06V 10/82

(52) U.S. Cl. CPC A63F 13/358; A63F 13/525; G06V 10/82; A63F 2300/66

(57) ABSTRACT

A method performed by a cloud server system can involve generating, for an asset of a gaming application, an object representation of the asset based at least in part on one or more images of the asset captured by a virtual camera. A first data size of the asset can be larger than a second data size of the object representation. The method can involve generating metadata indicating the second data size and properties of the object representation. The method can involve storing the object representation in association with the metadata. The method can involve, responsive to receiving a request for the asset from a client device, providing, based at least in part on the metadata, the object representation as input to a rendering engine executed by the client device.

### BACKGROUND

Modern game consoles, such as the PlayStation® 5 video game console, are sophisticated machines capable of providing engaging video game and entertainment experiences. A game console helps to streamline the gaming industry by providing a common platform of standardized resources (e.g., hardware and software) for the development, distribution, and execution of video games. In this manner, game developers can optimize their game development for the game console, and provide consumers with a seamless video game experience devoid of concerns about video game compatibility, optimization, or complicated setup with respect to the platform on which the game is run.

A fairly recent development enabled by the proliferation of the Internet is the rise of cloud gaming, in which a video game is executed remotely (e.g., in a remote data center), with gameplay being streamed over the Internet to a user’s local client device. More specifically, gaming inputs are transmitted from the client device over the Internet to the cloud executed video game, and the gameplay video generated by the video game is streamed over the Internet to the client device for rendering on a display.

However, while such advantages of the game console ecosystem are afforded for the consumer, because of the proprietary nature of game console hardware, supporting game development can be more complex. The game console must be adapted in various ways to accommodate the needs of game developers, or additional specialized hardware must be created to enable game development. Furthermore, these game development specialized systems are not easily adapted for cloud-based development.

### BRIEF DESCRIPTION OF THE DRAWINGS

The disclosure may be better understood by reference to the following description taken in conjunction with the accompanying drawings in which:

FIG. 1 illustrates an example computing environment for cloud game development using object representations as asset placeholders, according to an embodiment of the present disclosure.

FIG. 2 illustrates an example of a computing environment for cloud game development using neural object representations as asset placeholders, according to an embodiment of the present disclosure.

FIG. 3 illustrates an example of a computing environment for cloud game development using three-dimensional object representations as asset placeholders, according to an embodiment of the present disclosure.

FIG. 4 illustrates an example flow for performing cloud game development using object representations as asset placeholders, according to an embodiment of the present disclosure.

FIG. 5 illustrates another example computing environment for cloud game development using object representations as asset placeholders, according to an embodiment of the present disclosure.

FIG. 6 illustrates an example of a computer system suitable for implementing techniques of the present disclosure, according to embodiments of the present disclosure.

In the appended figures, similar components and/or features can have the same reference label.

### DESCRIPTION OF ILLUSTRATIVE EMBODIMENTS

Embodiments of the present disclosure are directed to, among other things, generating three-dimensional object representations to use as placeholders for large-scale assets in cloud gaming development. For example, a client device may access a portion (e.g., digital content such as a game level, an in-game region, etc.) of a gaming application in development, such as by downloading the portion to the client device. The portion may include several assets, such as three-dimensional models, textures, graphics, artwork, sounds, animations, or any other individual pieces (or a combination of individual pieces) of digital content that make up a gaming application. A developer using the client device may be developing some aspects of the gaming application, but many or even most of the downloaded assets may be irrelevant for such development. Thus, to reduce latency in transferring gaming application data and to more efficiently consume computing resources (e.g., due to data sizes), the cloud server system hosting the gaming application can generate object representations of certain assets to use as placeholder representations when transferring to the client device.

To illustrate, consider the following particular example. A gaming application may include a level set in a floor of a museum, which may include artwork assets such as paintings, sculptures, and the like. The paintings and sculptures may be realistically rendered with a relatively high level of detail, and thus digital files for the artwork assets may be relatively large. A developer may use a client device to develop or test weapon effects for a player character on the floor. The client device may be remotely located from a cloud server system that hosts the gaming application. Such development of weapons effects may not involve any modifications or even any interactions with the artwork assets. But, because the artwork assets may be large in size, such as up to multiple terabytes each, it may take significant amounts of time (e.g., up to hours) for the entire floor of the museum to be downloaded from the cloud server system and rendered on the client device. Then, the client device may continue to render large-scale artwork assets while developing unrelated portions of the gaming application, further consuming unnecessary computing resources and possibly providing a less than optimally responsive user interface (e.g., one with notable lag).

Thus, rather than transferring irrelevant large-scale assets as-is to the client device, the cloud server system can instead generate placeholder representations for such large-scale assets. The cloud server system can host a gaming engine used to create the gaming application. The gaming engine can include a virtual camera that can capture images of a large-scale three-dimensional asset, such as a sculpture on the museum floor. The images can be captured at different angles at which a player character may view the sculpture. Then, the images can be used to generate an object representation of the sculpture that can have a significantly smaller data size than the high-fidelity sculpture.

In some examples, the object representation may be a neural three-dimensional object representation, such as a Gaussian splat. A neural three-dimensional object representation may also be referred to as a neural volumetric representation or a neural volumetric three-dimensional representation. In other examples, the object representation may be a three-dimensional object representation made from the two-dimensional images. Although such object representations can have a significantly smaller data size than the high-fidelity asset, the object representations may preserve the same dimensions and properties of the asset. In some examples, the visual properties of an object representation used as a placeholder may be identical to the original large-scale asset that is rendered with polygons or voxels. By having the same dimensions and a similar or identical visual appearance, the object representations can be used as placeholders without negatively affecting the development of other gaming assets.

Embodiments of the present disclosure can provide several advantages over existing techniques in cloud gaming development. Conventional techniques may involve downloading large-scale polygonal or voxel assets, which may be time consuming and unnecessary in many development situations. Conventional techniques may also involve replacing large-scale assets with irrelevant placeholders, such as gray boxes that may have a similar volume to the large-scale asset but may have little to no visual similarities or entirely different dimensions than the large-scale asset. By generating smaller-size object representations based on virtual camera images of the large-scale asset, embodiments described herein can significantly reduce latency involved in transferring portions of a gaming application to a remote client device. The remote client device may consume fewer computing resources by rendering lower-scale assets that are visually similar or even identical to the original large-scale assets.

For example, embodiments described herein can involve using machine learning to generate neural object representations that can have the same dimensions and visual properties as the large-scale assets that are rendered with polygons or voxels. The neural object representation may exactly replicate visual effects, such as lighting and mirror effects from viewing the neural object representation at different angles, if such effects were captured by the virtual camera of the game engine. Thus, from the developer’s perspective, there may be no visual difference in rendering the neural object representation versus the large-scale asset, particularly if the developer is not testing interactions with the object (e.g., sculpture). Further, although the neural object representation may be generated using a game engine, any platform that can render neural objects may download and render the neural object representation. For instance, the client device may download and render the neural object representation within a suitable web browser without using the game engine at all.

In the interest of clarity of explanation, the embodiments can be described in connection with development of a video game system including a video game console, such as a virtual gaming consol hosted by a cloud server system. However, the embodiments are not limited as such and can similarly apply to any other type of a computer system.

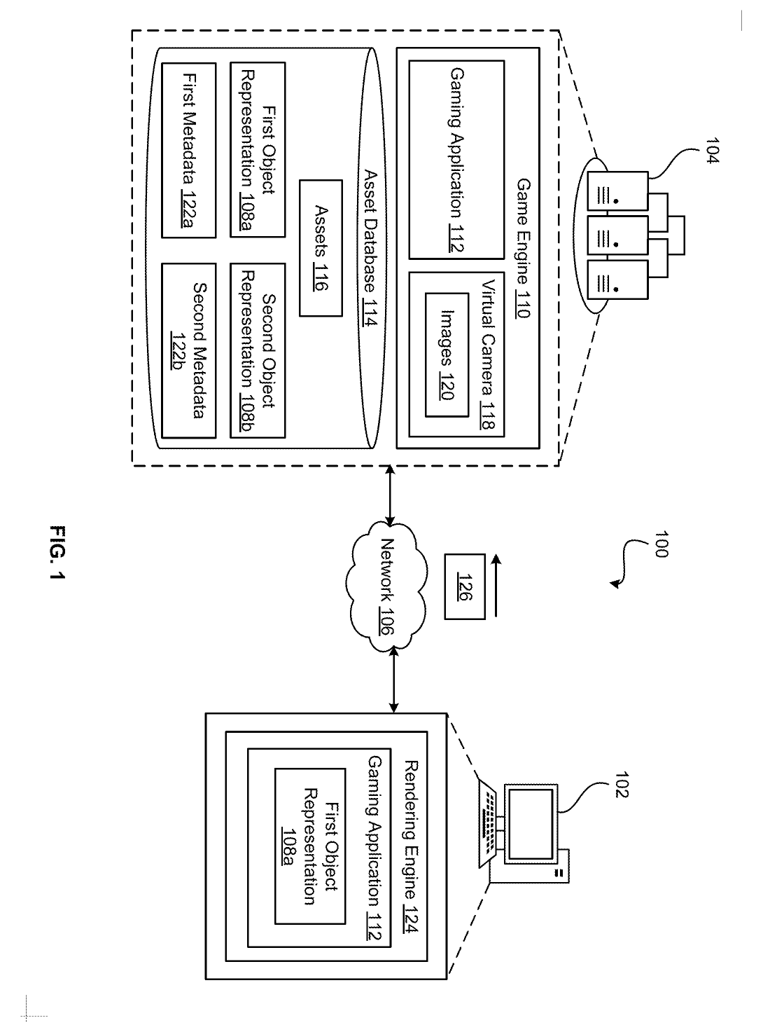

FIG. 1 illustrates an example computing environment 100 for cloud game development using object representations 108a-b as asset placeholders, according to an embodiment of the present disclosure. The computing environment 100 can include a client device 102 and a cloud server system 104 communicatively coupled via a wireless network 106 (e.g., the Internet). The cloud server system 104 can host a gaming application 112 via a game engine 110. An example of the game engine 110 can be Unreal® Engine. The gaming application 112 may be in development. For example, the client device 102 may be used to access portions of the gaming application 112, such as by modifying or adding code to the gaming application 112. To do so, the client device 102 may download a copy of some or all of the gaming application 112 from the cloud server system 104 via the network 106. The client device 102 may modify the gaming application 112 and then upload modified features of the gaming application 112 back to the cloud server system 104.

The cloud server system 104 may also include an asset database 114 storing assets 116 of the gaming application 112. Assets 116 can be digital content (e.g., data objects) that make up the gaming application 112, such as representations of characters, buildings, vehicles, textures, sounds, animations, props, or any other elements (e.g., individual elements or a combination of elements) of the gaming application 112. Assets 116 may have dimension (e.g., may be two-dimensional or three-dimensional) and may have various attributes, including visual properties. Some assets 116 may be relatively large in order to be rendered with high fidelity. For instance, some assets 116 may have data sizes of terabytes or more.

In cloud gaming development, it may be common for developers to be distributed around the world. Thus, accessing some or all portions of the gaming application 112 to develop the gaming application 112 may involve downloading large-scale assets 116 over significant distances, such as over thousands of miles. In many cases, a developer may work on a portion of the gaming application 112 that includes large-scale assets 116 that may not be modified during a development session. For example, the gaming application 112 may be a racecar video game. The developer may wish to test different models of cars on a racetrack in the gaming application 112. The racecar setting may include assets 116 such as trees, plants, signage, and the like that may be large-scale assets that are rendered with polygons or voxels. Such assets 116 may not, in some examples, be interactable. For instance, a tree asset may be positioned within a region of the racetrack that is inaccessible to a car driving on the racetrack. Therefore, testing different models of cars on the racetrack may have little to no effect on the visual rendering of the tree assets. It may be a waste of computing resources for the client device 102 to download and fully render such large-scale assets 116 in testing models of cars.

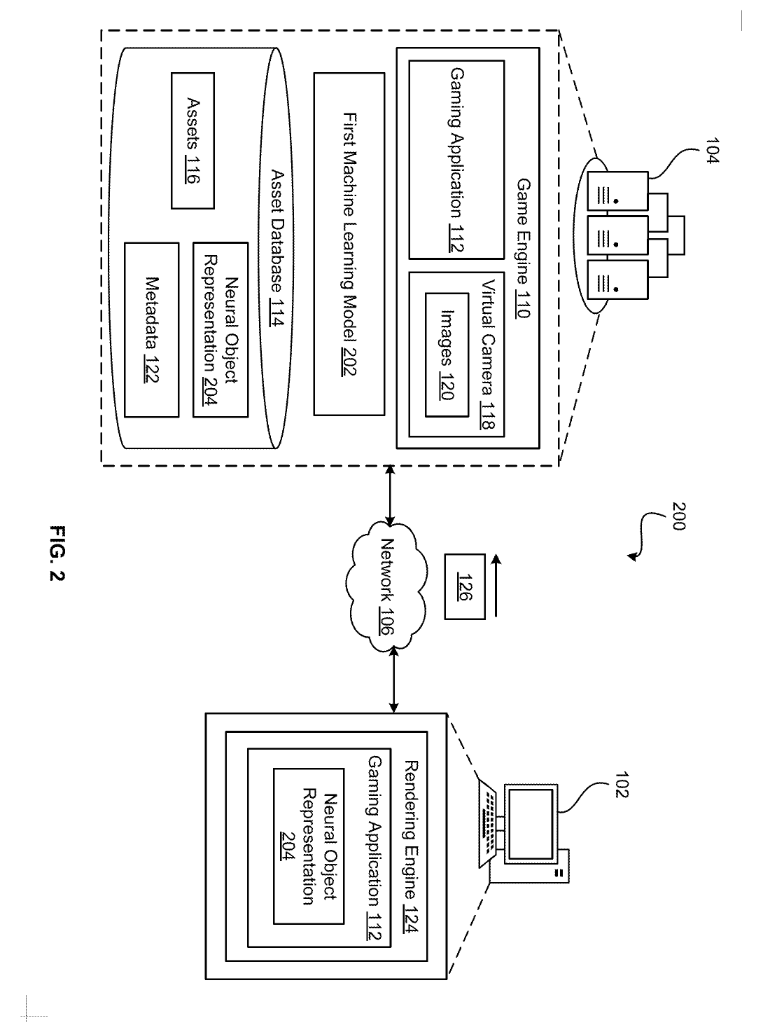

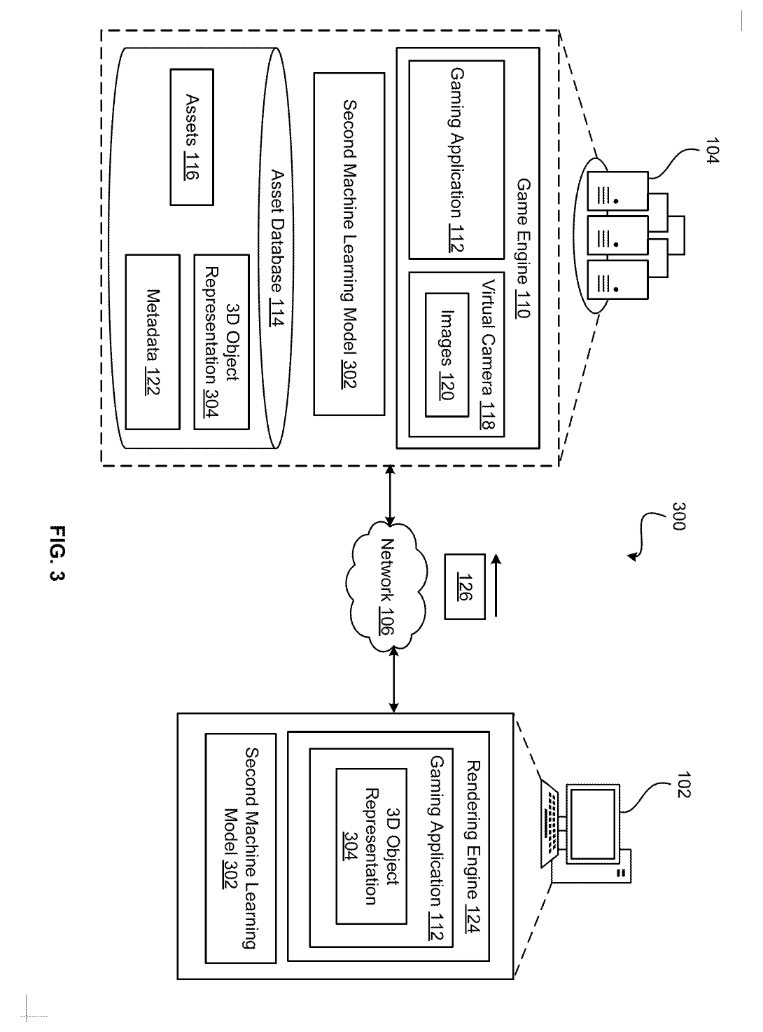

To reduce latency in developing the racetrack, the cloud server system 104 can generate object representations 108a-b of such large-scale assets 116. The object representations 108a-b can be visually similar or identical placeholders for the large-scale assets 116 using a virtual camera 118 of the game engine 110. For example, the virtual camera 118 can spin around an asset 116, such as a tree asset, to capture images 120 of the asset 116. In some examples, the virtual camera 118 may only capture images 120 that are viewable from the perspective of a playable character (e.g., for a car on the racetrack). The images 120 can then be used to generate one or more object representations 108a-b. Examples of generation of the object representations 108 are described in further detail in FIGS. 2-3. In some examples, the images 120 of the asset 116 can be captured on their own against a background. For example, the asset 116 depicted in an image 120 can be silhouetted against a background that does not depict other assets in the gaming application 112. The background may be a blank background (e.g., the background pixels may have no value, may have transparency alpha values, or may be a colored background such as a black or a white background). Capturing images 120 that depict only the asset 116 without other assets or features in the gaming application 112 can improve the accuracy of subsequent generation of the object representations 108a-b.

The object representations 108a-b can have the same dimensions (e.g., volumetric representation) as the asset 116 and may have some or all visual properties in common. In some examples, if captured by the virtual camera 118, the object representations 108a-b may have animated features, such as leaves of the tree blowing in the wind. Other visual effects, such as lighting or mirroring, may also be replicated in the object representations 108a-b if captured by the virtual camera 118. As the object representations 108a-b may have volume (e.g., the same volume as the asset 116), other objects in the gaming application 112 may collide with the object representations 108a-b. In some examples, the object representations 108a-b may not have the same interactable features as their corresponding large-scale asset 116, but can faithfully represent the large-scale asset 116 in a rendering of the gaming application 112.

In some examples, the cloud server system 104 may generate object representations 108a-b of differing data sizes or resolutions for the same large-scale asset 116 (e.g., while still having a smaller data size than the large-scale asset 116). For example, a first object representation 108a can be a picture-perfect yet lower-data size representation of the large-scale asset 116 with the same visual properties. The second object representation 108b may also have a lower data size than the large-scale asset 116, but may have a lower resolution (and thus lower data size) than the first object representation 108a. For example, the game engine 110 may render the asset 116 in the gaming application 112 in a lower resolution setting, and the virtual camera 118 may capture relatively lower-resolution images 120 of the asset 116 that are used to generate the second object representation 108b.

Each of the first object representation 108a and the second object representation 108b can be stored in the asset database 114 in association with corresponding metadata 122a-b. The metadata 122a-b can indicate the associated large-scale asset 116, the resolution, or any other relevant properties of the corresponding object representations 108a-b. The metadata 122a-b may also indicate appropriate instances to replace rendering of the asset 116 with rendering of one of the object representations 108a-b. For example, the metadata 122a-b may include tags indicating types of testing or bandwidth thresholds for sending various object representations 108a-b.

In some examples, when a new asset 116 is stored in the asset database 114, the cloud server system 104 may automatically generate one or more object representations 108a-b for the corresponding asset 116 to also be stored in the asset database 114. In other examples, an object representation 108 may be generated on demand (e.g., in response to a request 126 from the client device 102) and stored in the asset database 114. Future requests for the asset 116 or a representation of the asset 116 may be fulfilled with the stored object representation 108. Depending on the size of the asset 116, generating a lower-data size object representation 108 and transferring the object representation 108 to the client device 102 may still consume less computing resources and/or network bandwidth than transferring the large-scale asset 116 to the client device 102.

To use the object representation 108, the client device 102 may transmit a request 126 to the cloud server system 104 to download the gaming application 112 for development (or, in some examples, a portion of the gaming application 112, such as the racetrack to use in testing different models of cars). In some examples, the request 126 may specify the kind of development that will be performed on the client device 102. In some examples, the request 126 may include a request to transfer an object representation, such as the first object representation 108a, as a placeholder replacement for a large-scale asset 116, such as a tree that is outside of an interactable zone of the racetrack. In other examples, the cloud server system 104 may determine whether to transfer the large-scale asset 116 itself or a placeholder replacement, such as first object representation 108a.

For example, the cloud server system 104 may dynamically select one of the object representations 108a-b of the large-scale asset 116 to transfer based on the type of content being tested at the client device 102, the type of developer developing the gaming application 112, specifications of the client device 102, available bandwidth for the network 106, or any other suitable factors. Such factors may be detected by the cloud server system 104 and/or indicated in the request 126. For example, if the available bandwidth of the network 106 for the client device 102 is below a predefined threshold, the cloud server system 104 may transmit the second object representation 108b to the client device 102 to fulfill the request 126, as the second object representation 108b may have the lowest data size (e.g., as indicated by second metadata 122b). The cloud server system 104 may also select a type of object representation to transmit to the client device 102, such as selecting one of a neural object representation or a three-dimensional object representation based on network bandwidth, device specifications, type of testing, type of developer, etc.

Thus, the cloud server system 104 can respond to the request 126 by transferring data files for the requested portion of the gaming application 112 to the client device 102, with the large-scale asset 116 replaced with the selected object representation 108 (e.g., first object representation 108a). The client device 102 may download the transferred data files that include the first object representation 108a significantly faster than if the transferred data files included the large-scale asset 116. The client device 102 may execute a rendering engine 124 to render the transferred and downloaded data files into a presentation of the gaming application 112 that includes the first object representation 108a. The developer can then modify and otherwise develop the portion of the gaming application 112, such as by testing different models of cars on the racetrack, without any loss of visual integrity from using the first object representation 108a as a representative placeholder of the large-scale asset 116. In some examples, the cloud server system 104 may periodically (e.g., during developer or player downtime, such as overnight, after check-in of the asset 116, or by request) generate object representations 108 of some or all assets 116 in the asset database 114. Pre-generating the object representations 108 can further reduce latency, such that future requests for an asset 116 can be automatically fulfilled with a corresponding object representation 108 (e.g., without having to wait for the object representation 108 to be generated).

In some examples, the rendering engine 124 may be the same engine as the game engine 110 hosted by the cloud server system 104. In other examples, the rendering engine 124 may be any engine that can render the features of the transferred portion of the gaming application 112, including a web browser engine. For example, because the first object representation 108a may be a three-dimensional object representation or a neural object representation, a large-scale game engine 110 such as Unreal® Engine may not be necessary to render the first object representation 108a. The client device 102 may instead use a lighter weight rendering engine 124 such as a web browser engine, thus further conserving computing resource usage of the client device 102.

FIG. 2 illustrates an example of a computing environment 200 for cloud game development using neural object representations 204 as asset placeholders, according to an embodiment of the present disclosure. The computing environment 200 can include the client device 102 and the cloud server system 104 of FIG. 1, in which the cloud server system 104 can respond to requests for assets 116 from the client device 102 by generating and transferring neural object representations 204 of the asset 116 to the client device 102. The cloud server system 104 can use a virtual camera 118 of a game engine 110 to capture images 120 (e.g., at different angles) of the asset 116 to use in generating the neural object representation 204.

For example, the cloud server system 104 may execute a first machine learning model 202 to generate the neural object representation 204 based on an input of the images 120 captured by the virtual camera 118. In some examples, the neural object representation 204 can include three-dimensional or four-dimensional Gaussian splats, but any other suitable neural rendering that has a volume that can occupy a three-dimensional space (e.g., the same three-dimensional space as the asset 116 with the same dimensions) can be used. In contrast with polygonal or voxel rendering of the large-scale asset 116, the neural object representation 204 can instead be a neural rendering that constructs a three-dimensional object from two-dimensional images. The first machine learning model 202 may be, for example, a deep neural network (DNN), but any suitable machine learning model that can generate neural object representations may be used.

The neural object representation 204 may, in some examples, be rendered as an exact visual replica of the large-scale asset 116, as long as the virtual camera 118 captured images 120 depicting the full resolution of the asset 116. The virtual camera 118 may capture images 120 from different angles, such as by “spinning around” the asset 116 in-game. In some examples, the images 120 may be captured in various scenarios, such as various lighting scenarios. Thus, the resulting visual appearance of the neural object representation 204 can reflect different lighting scenarios when rendered by the client device 102.

For example, the neural object representation 204 may have a different visual appearance in a daytime mode of the gaming application 112 versus a nighttime mode, which may mirror the visual appearance of the asset 116 in the daytime mode or nighttime mode. Other visual characteristics such as mirroring, reflectivity, color changes, etc. of the asset 116 can also be exactly replicated on the neural object representation 204. Thus, when the neural object representation 204 is rendered on the client device 102, there may be no difference in visual appearance between the neural object representation 204 versus using the asset 116. This may be particularly beneficial if the asset 116 (e.g., the neural object representation 204) is not being developed or interacted with for the development session by the client device 102.

FIG. 3 illustrates an example of a computing environment 300 for cloud game development using three-dimensional (3D) object representations as asset placeholders, according to an embodiment of the present disclosure. The computing environment 300 can include the client device 102 and the cloud server system 104 of FIG. 1, in which the cloud server system 104 can respond to requests for assets 116 from the client device 102 by generating and transferring 3D object representations 304 of the asset 116 to the client device 102. The cloud server system 104 can use a virtual camera 118 of a game engine 110 to capture images 120 (e.g., at different angles) of the asset 116 to use in generating the 3D object representation 304.

For example, the cloud server system 104 may execute a second machine learning model 302 to generate the 3D object representation 304 based on an input of the images 120 captured by the virtual camera 118. The second machine learning model 302 may be, for example, an image-to-3D model generator. The 3D object representation 304 may have the same dimensions as the asset 116 and may have a significantly smaller data size than the asset 116. In some examples, a 3D object representation 304 may have a smaller data size than a corresponding neural object representation of the same asset 116. Further, in some examples, the second machine learning model 302 may generate the 3D object representation 304 with significantly fewer pictures than may be used by the first machine learning model 202 of FIG. 2 to generate a corresponding neural object representation. Thus, transferring a 3D object representation 304 to the client device 102 may, in some examples, be better suited for lower network bandwidth connections or client devices with restricted computing resources.

In some examples, rather than transferring the 3D object representation 304 to the client device 102 (e.g., upon receiving a request 126 for the asset 116), the cloud server system 104 can fulfill the request by instead transferring the images 120 to the client device 102. The client device 102 may execute the second machine learning model 302 to generate the 3D object representation 304 based on the images 120. Transferring the images 120 rather than the 3D object representation 304 may further reduce latency in fulfilling the request 126. The client device 102 may, in some examples, transmit the generated 3D object representation 304 to the cloud server system 104. The cloud server system 104 can generate metadata 122 for the 3D object representation 304 and can store the 3D object representation 304 in the asset database 114 in the asset database 114 in association with the metadata 122. Thus, when future requests are received for the asset 116, the 3D object representation 304 can be retrieved and used to fill the requests.

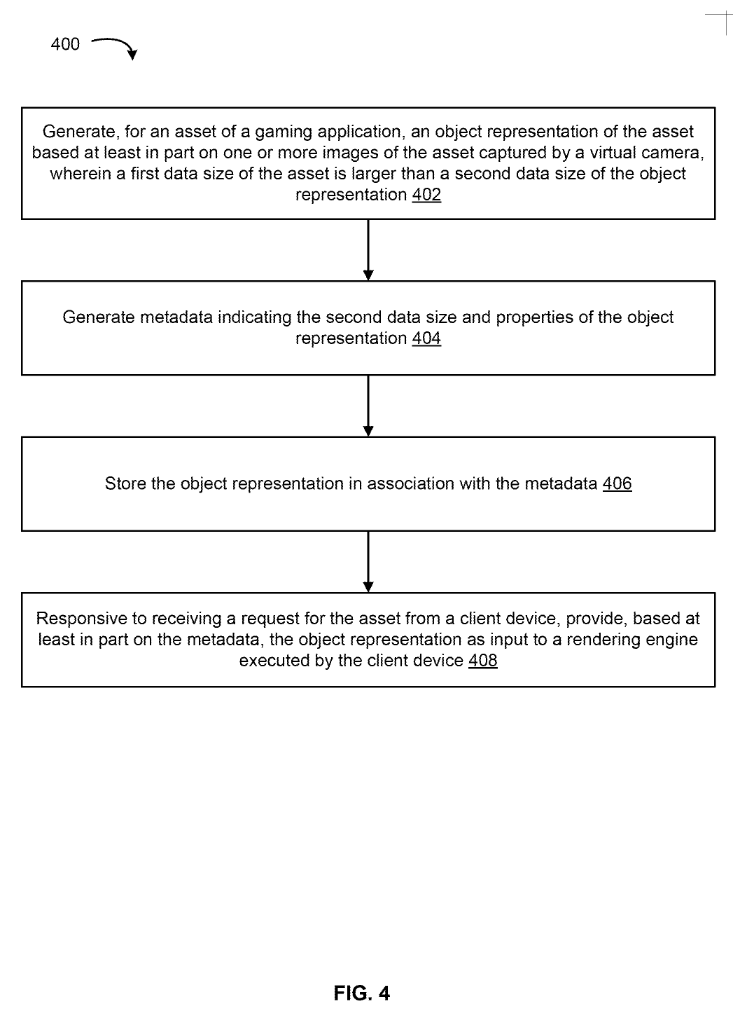

FIG. 4 illustrates an example flow 400 for performing cloud game development using object representations as asset placeholders, according to an embodiment of the present disclosure. The operations of flow 400 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, the flow 400 can include operation 402, which involves generating, by a cloud server system and for an asset of a gaming application, an object representation of the asset based at least in part on one or more images of the asset captured by a virtual camera. A first data size of the asset can be larger than a second data size of the object representation. In some examples, the object representation may have the same set of dimensions and at least one visual property in common with the asset. In some examples, by using the virtual camera to capture images of the asset, the object representation may be an exact visual representation of the asset (e.g., with the same resolution or other visual properties, such as reflectiveness, mirroring, lighting, coloring, animation, etc.). In some examples, the object representation may have a lower resolution than the asset.

In some examples, the cloud server system may generate the object representation by at least executing a first machine learning model. The first machine learning model may be, for example, a deep neural network. The first machine learning model can use the one or more images as input to generate an object representation that is a neural object representation. The neural object representation can be rendered as a neural rendering, as opposed to a polygonal or voxel rendering of the asset.

Additionally or alternatively, the cloud server system may generate the object representation by at least using a second machine learning model. The second machine learning model can be an image-to-three-dimensional (3D) machine learning model. The second machine learning model can use the one or more images (e.g., two-dimensional (2D) images of the asset) as input to generate an object representation that is a 3D object representation.

In some examples, the cloud server system may generate multiple object representations for a single asset. For example, the object representation may be a first object representation and the metadata can be a first metadata. The cloud server system may also generate, for the same asset, a second object representation of the asset. A third data size of the second object representation may be smaller than the second data size of the first object representation. In some examples, this may be due to a first resolution of the first object representation being greater than a second resolution of the second object representation. Additionally or alternatively, this may be due to the first object representation being a neural object representation and the second object representation being a three-dimensional object representation.

In an example, the flow 400 can include operation 404, which involves generating, by the cloud server system, metadata indicating the second data size and properties of the object representation. The properties may include, for example, a resolution of the object representation, a type of the object representation (e.g., whether the object representation is a three-dimensional object representation or a neural object representation), or any other relevant information associated with the object representation. The metadata may include tags indicating appropriate situations for using the object representation as a placeholder for the asset.

In an example, the flow 400 can include operation 406, which involves storing, by the cloud server system, the object representation in association with the metadata. Thus, when the cloud server system receives future requests for the asset, the cloud server system may fulfill such requests by accessing the object representation (e.g., from an asset database) instead of generating a new object representation.

In an example, the flow 400 can include operation 408, which involves providing, by the cloud server system and based at least in part on the metadata, the object representation as input to a rendering engine executed by the client device. The object representation can be provided as input to the rendering engine responsive to receiving a request for the asset from the client device. The object representation may be provided as input instead of providing the asset as input. Because the object representation may have a significantly smaller data size (e.g., many orders of magnitude smaller) than the asset, which may be a large-scale asset with gigabytes or even terabytes of data, transferring the object representation to the client device via a wireless network may consume significantly less network bandwidth and take less time than transferring the large-scale asset to the client device.

In some examples where an asset has multiple associated object representations, the cloud server system may respond to the request for the asset by selecting one of the associated object representations to provide. For example, the cloud server system may select one of the first object representation or the second object representation based on the first metadata, the second metadata, and on at least one of an available network bandwidth for the client device, a type of the request or a type of user for the client device.

In some examples, the cloud server system may transfer the object representation, such as a three-dimensional object representation or a neural object representation, to the client device (e.g., as input to the rendering engine executed by the client device). In other examples, the cloud server system may transfer two-dimensional images of the asset to the client device as the object representation (or to be used in generating the object representation). The two-dimensional images of the asset may enable the client device to generate a three-dimensional representation of the asset. For example, the client device may receive the two-dimensional images and execute a machine learning model to generate the object representation, such as a neural object representation or a three-dimensional object representation. The client device may then input the generated object representation into the rendering engine.

In some examples, the client device may then transfer the generated object representation to the cloud server system to be stored in an asset database of the cloud server system. When future requests for the same asset are received (e.g., by the client device or any other device, the cloud server system can access the object representation (generated either by the client device or the cloud server system) from the asset database to use in fulfilling the request. Thus, an object representation for a particular asset may be generated once but used repeatedly.

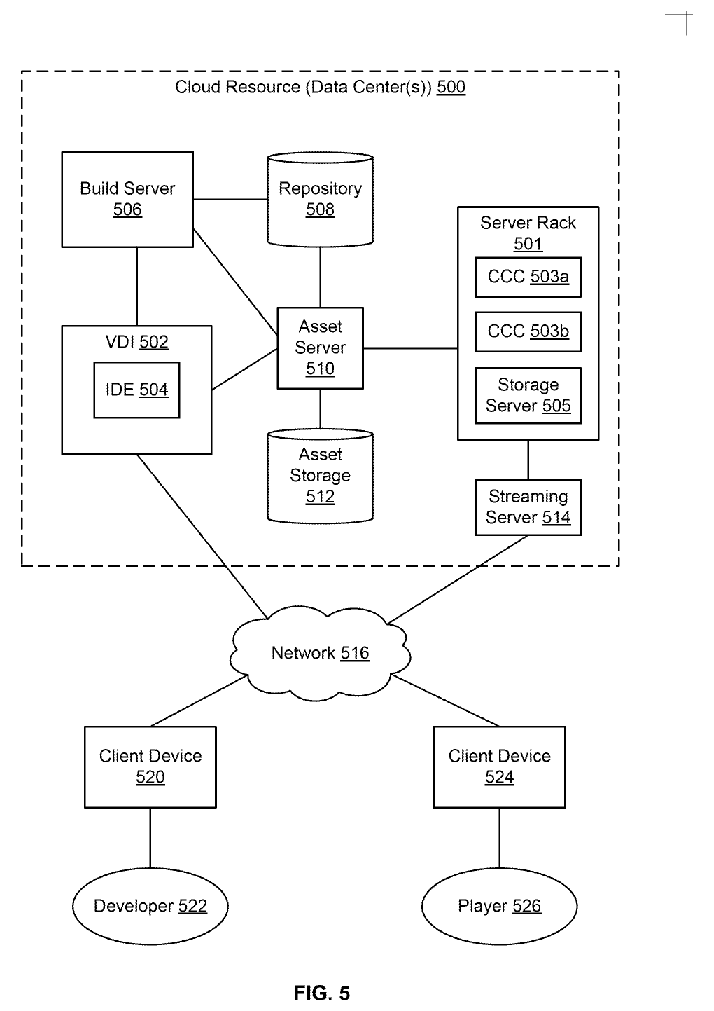

FIG. 5 illustrates another example computing environment for cloud game development using object representations as asset placeholders, according to an embodiment of the present disclosure. In the illustrated implementation, a cloud resource 500 having cloud processing and cloud storage resources is provided. The cloud resource 500 can be an example of the cloud server system 104 of FIGS. 1-3. In various implementations, the illustrated systems can be implemented in one or more data centers, connected over the Internet. For example, a server rack 501 can be implemented in a data center, and a given console compute card 503a can be assigned to a player 526 and client device 524 for gameplay of a given console video game title. The client device 524 can be an example of the client device 102 of FIGS. 1-3. The console compute card 503b will be loaded with the video game title, and gameplay will be streamed over network 516 (including the Internet) to the player’s client device 524. In some implementations, a streaming server 514 is implemented to manage video streaming to the client device 524, for example, to optimize the video stream for network conditions, the player’s hardware capabilities, etc.

In some implementations, a cloud-based game development platform is enabled by using the console compute cards in conjunction with game development systems. For example, a virtual desktop infrastructure 502 can be implemented that allows a developer 522 operating their client device 520 to access over network 516 a virtual desktop providing cloud-hosted tools for game development, such as an integrated development environment 504 or other development software (e.g. 3D rendering/animation software, etc.). The client device 520 may be an example of the client device 102 of FIGS. 1-3. An asset server 510 manages access to an asset storage 512 containing game assets such as textures, rigs, animations, audio, etc. A build server 506 manages access to various builds of video games, stored to a repository 508. The build server 506 can manage access to source code files, and compile source code into executables for deployment onto the console compute cards.

When a given executable build of a video game is executed by a console compute card, then the gameplay of the game build can be cloud streamed as previously described. For example, the player 526 may be a quality assurance (QA) tester or alpha/beta tester involved in supporting the development of the video game. In this manner, a cloud environment for end-to-end game development of console-based games is enabled, whereby game assets and builds are developed in the cloud, and testing on console-equivalent hardware is also cloud-based. This enables development teams and individuals, including software developers, artists, QA testers, project managers, etc. to engage and collaborate in game development activities remotely.

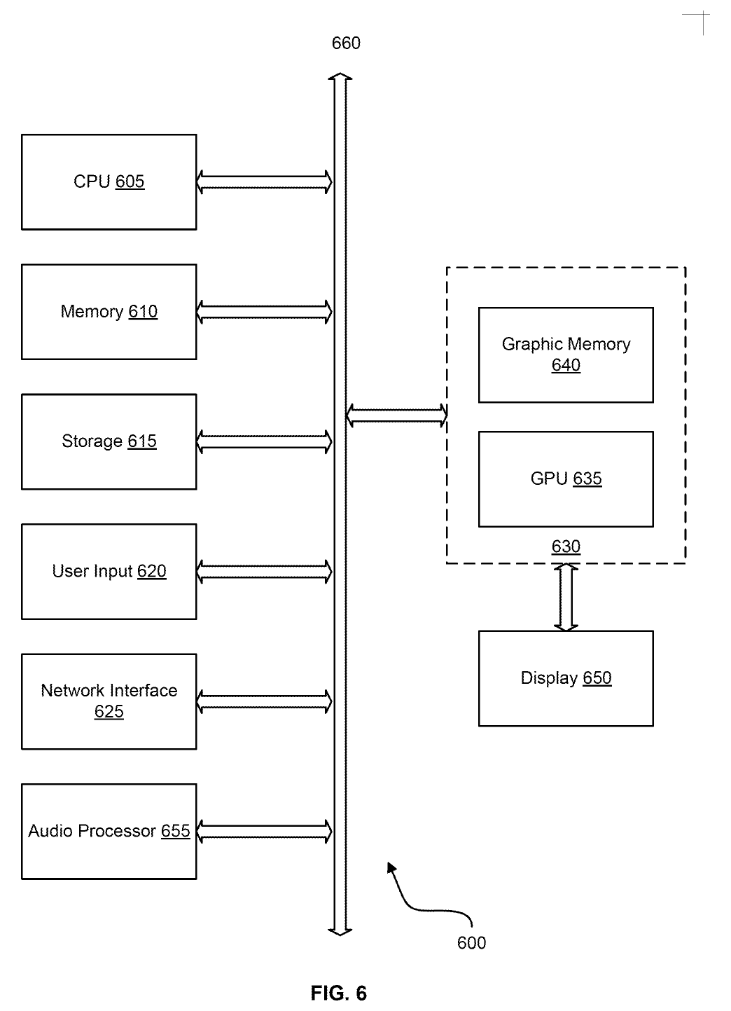

FIG. 6 illustrates an example of a computer system 600 suitable for implementing techniques of the present disclosure, according to embodiments of the present disclosure. The computer system 600 represents, for example, a video game system, a backend set of servers, or other types of a computer system. The computer system 600 includes a central processing unit (CPU) 605 for running software applications and optionally an operating system. The CPU 605 may be made up of one or more homogeneous or heterogeneous processing cores. Memory 610 stores applications and data for use by the CPU 605. Storage 615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 620 communicate user inputs from one or more users to the computer system 600, examples of which may include keyboards, mice, thumbsticks, touch pads, touch screens, still or video cameras, and/or microphones. Network interface 625 allows the computer system 600 to communicate with other computer systems via an electronic communications network and may include wired or wireless communication over local area networks and wide area networks such as the Internet. An audio processor 655 is adapted to generate analog or digital audio output from instructions and/or data provided by the CPU 605, memory 610, and/or storage 615. The components of computer system 600, including the CPU 605, memory 610, data storage 615, user input devices 620, network interface 625, and audio processor 655 are connected via one or more data buses 660.

A graphics subsystem 630 is further connected with the data bus 660 and the components of the computer system 600. The graphics subsystem 630 includes a graphics processing unit (GPU) 635 and graphics memory 640. The graphics memory 640 includes a display memory (e.g., a frame buffer) used for storing pixel data for each pixel of an output image. The graphics memory 640 can be integrated in the same device as the GPU 635, connected as a separate device with the GPU 635, and/or implemented within the memory 610. Pixel data can be provided to the graphics memory 640 directly from the CPU 605. Alternatively, the CPU 605 provides the GPU 635 with data and/or instructions defining the desired output images, from which the GPU 635 generates the pixel data of one or more output images. The data and/or instructions defining the desired output images can be stored in the memory 610 and/or graphics memory 640. In an embodiment, the GPU 635 includes 3D rendering capabilities for generating pixel data for output images from instructions and data defining the geometry, lighting, shading, texturing, motion, and/or camera parameters for a scene. The GPU 635 can further include one or more programmable execution units capable of executing shader programs.

The graphics subsystem 630 periodically outputs pixel data for an image from the graphics memory 640 to be displayed on the display device 650. The display device 650 can be any device capable of displaying visual information in response to a signal from the computer system 600, including CRT, LCD, plasma, and OLED displays. The computer system 600 can provide the display device 650 with an analog or digital signal.

In accordance with various embodiments, the CPU 605 is one or more general-purpose microprocessors having one or more processing cores. Further embodiments can be implemented using one or more CPUs 605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature’s relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising, by a cloud server system:
generating, for an asset of a gaming application, an object representation of the asset based at least in part on one or more images of the asset captured by a virtual camera, wherein a first data size of the asset is larger than a second data size of the object representation;
generating metadata indicating the second data size and properties of the object representation;
storing the object representation in association with the metadata; and
responsive to receiving a request for the asset from a client device, providing, based at least in part on the metadata, the object representation as input to a rendering engine executed by the client device.

2. The method of claim 1, wherein the object representation has a same set of dimensions and at least one visual property in common with the asset.

3. The method of claim 1, wherein the object representation has a lower resolution than the asset.

4. The method of claim 1, wherein the object representation is a first object representation and the metadata is first metadata, and wherein the method further comprises:
generating, for the asset, a second object representation of the asset, wherein a third data size of the second object representation is smaller than the second data size of the first object representation, and wherein a first resolution of the first object representation is greater than a second resolution of the second object representation; and
generating second metadata indicating the third data size and second resolution of the second object representation.

5. The method of claim 4, further comprising:
selecting, based on the first metadata, the second metadata, and on at least one of an available network bandwidth for the client device, a type of the request, or a type of user for the client device, one of the first object representation or the second object representation to use in a response to the request.

6. The method of claim 1, wherein generating the object representation of the asset further comprises:
generating, by at least using the one or more images as input to a machine learning model, the object representation, wherein the object representation includes a neural object representation.

7. The method of claim 1, wherein generating the object representation of the asset further comprises:
generating, by at least using the one or more images as input to a machine learning model, the object representation, wherein the object representation includes a three-dimensional object representation.

8. The method of claim 1, wherein the object representation includes a plurality of two-dimensional images of the asset, the plurality of two-dimensional images enabling the client device to generate a three-dimensional representation of the asset.

9. A system comprising:
one or more processors; and
one or more memories storing executable instructions that, upon execution by the one or more processors, cause the system to perform operations to:
generate, for an asset of a gaming application, an object representation of the asset based at least in part on one or more images of the asset captured by a virtual camera, wherein a first data size of the asset is larger than a second data size of the object representation;
generate metadata indicating the second data size and properties of the object representation;
store the object representation in association with the metadata; and
responsive to receiving a request for the asset from a client device, provide, based at least in part on the metadata, the object representation as input to a rendering engine executed by the client device.

10. The system of claim 9, wherein the object representation has a same set of dimensions and at least one visual property in common with the asset.

11. The system of claim 9, wherein the object representation has a lower resolution than the asset.

12. The system of claim 9, wherein the object representation is a first object representation and the metadata is first metadata, and wherein the operations further comprise:
generating, for the asset, a second object representation of the asset, wherein a third data size of the second object representation is smaller than the second data size of the first object representation, and wherein a first resolution of the first object representation is greater than a second resolution of the second object representation; and
generating second metadata indicating the third data size and second resolution of the second object representation.

13. The system of claim 12, wherein the operations further comprise:
selecting, based on the first metadata, the second metadata, and on at least one of an available network bandwidth for the client device, a type of the request, or a type of user for the client device, one of the first object representation or the second object representation to use in a response to the request.

14. The system of claim 9, wherein generating the object representation of the asset further comprises:
generating, by at least using the one or more images as input to a machine learning model, the object representation, wherein the object representation includes a neural object representation.

15. The system of claim 9, wherein generating the object representation of the asset further comprises:
generating, by at least using the one or more images as input to a machine learning model, the object representation, wherein the object representation includes a three-dimensional object representation.

16. The system of claim 9, wherein the object representation includes a plurality of two-dimensional images of the asset, the plurality of two-dimensional images enabling the client device to generate a three-dimensional representation of the asset.

17. A computer-readable storage medium storing computer-executable instructions that, when executed by one or more processors, cause operations comprising:
generating, for an asset of a gaming application, an object representation of the asset based at least in part on one or more images of the asset captured by a virtual camera, wherein a first data size of the asset is larger than a second data size of the object representation;
generating metadata indicating the second data size and properties of the object representation;
storing the object representation in association with the metadata; and
responsive to receiving a request for the asset from a client device, providing, based at least in part on the metadata, the object representation as input to a rendering engine executed by the client device.

18. The computer-readable storage medium of claim 17, wherein the object representation has a same set of dimensions and at least one visual property in common with the asset.

19. The computer-readable storage medium of claim 17, wherein the object representation has a lower resolution than the asset.

20. The computer-readable storage medium of claim 17, wherein the object representation is a first object representation and the metadata is first metadata, and wherein the operations further comprises:
generating, for the asset, a second object representation of the asset, wherein a third data size of the second object representation is smaller than the second data size of the first object representation, and wherein a first resolution of the first object representation is greater than a second resolution of the second object representation; and
generating second metadata indicating the third data size and second resolution of the second object representation.
